(19) United States
(12) Patent Application Publication
(10) Pub. No.: US 2015/0209970 A1
(43) Pub. Date: Jul. 30, 2015

(54) FORMING TOTAL PORTIONS

(71) Applicant: Weber Maschinenbau GmbH Breidenbach, Breidenbach (DE)

(72) Inventor: Gunther Weber, GroB Nemerow (DE)

(21) Appl. No.: 14/606,244

(22) Filed: Jan. 27, 2015

(30) Foreign Application Priority Data
Jan. 28, 2014 (DE) 102014101008.6

(51) Int. Cl. B26D 5/00; B26D 7/32

(52) U.S. Cl. CPC B26D 5/007; B26D 7/32

(57) ABSTRACT

The invention relates to an apparatus for forming total portions which at least comprise product slices which are cut off from a plurality of food products, having a machine assembly having a plurality of machine units comprising a plurality of slicing apparatus and a placement device which comprises at least one placement region travelable between the slicing apparatus, having a display device, having an evaluation device communicating with the display device, and having a system control which communicates with individual controls associated with the machine units and with the configuration device, wherein a respective total portion can be created from a plurality of different individual portions by means of the display device.

The invention relates to an apparatus and to a method for forming total portions which at least comprise product slices which are cut off from a plurality of food products, in particular from food products of different types, wherein the total portions each comprise a plurality of individual portions which are each formed from at least one product slice.

The manufacture of so-called multi-type packages for foods with the aid of one or more high-performance slicers is generally known. The demands on the manufacturers of such packages are becoming increasingly larger, in particular with respect to the variant variety and the cost pressure. In this respect, it is not only important to provide the devices, in particular the slicing and conveying technology, required for a plurality of different products. Great importance also accrues to a setting up of an existing networked machine system which is as simple and as fast as possible, and indeed in particular when production has to be converted to a different multi-type packaging. This not only costs time with complex systems, but also requires a lot of knowledge and experience on the part of the operators. In other words, it is not only the system itself, but also its operation which results in a considerable cost increase if the manufacture wants to have the capability to be able to product as large a variety as possible of different multi-type packaging on a batch by batch basis.

It is known from EP 1 762 346 A1 to “create” portions comprising a plurality of slices in a similar manner by means of a touchscreen, the slices being produced automatically by means of a single slicer on the basis of the portion design created at the touchscreen. This solution only allows a portion produced from a single product type to be varied with respect to the arrangement of the individual product slices with respect to one another.

It is the object of the invention to make possible the production of total portions of the initially named kind with a large variant variety in a simple and inexpensive manner.

This object is satisfied by the features of the apparatus claim 1 and by the features of the method claim 19.

The apparatus in accordance with the invention comprises a machine assembly having a plurality of machine units with which a respective single control is associated; a configuration device having a display device and an evaluation device communicating with the display device; and a system control which communicates with the individual controls of the machine unit and with the configuring device.

The machine units comprise a plurality of slicing apparatus and a placement device which comprises at least one placement region which can be traveled between the slicing apparatus and on which a total portion of product slices cut-off by means of the slicing apparatus is formed. The slicing apparatus are in particular respective high-performance slicers which each have a product feed with which at least one product to be sliced is fed to a cutting plane in which a cutting blade moves, in particular in a rotating and/or revolving manner.

In accordance with the invention, a respective total portion can be created from a plurality of different individual portions by means of the display device. The evaluation device is configured to provide a configuration data set determined by a predefined total portion, in particular a created total portion. The system control is configured to predefine a machine data set from a provided configuration data set and to control the machine assembly on the basis of the predefined machine data set such that total portions are formed which correspond to the predefined total portion, in particular to the created total portion, in that individual portions formed successively by different slicing apparatus are placed on the placement area of the placement device, in particular in an overlapping manner.

The invention makes it possible for the user first to create a respective desired total portion comprising a plurality of individual portions in accordance with the respective demands in graphic form by means of the display device. The apparatus can then provide—in particular fully automatically—that the individual machine assemblies are controlled such that they produce the previously created total portion.

The invention consequently not only allows the control of a single slicer on the basis of a previously created portion, as is described in the initially mentioned EP 1 762 346 A1. It is rather the case that a complete system of networked machines can be controlled on the basis of a total product by the invention, for the production of which not only a plurality of slicing apparatus are required, but these slicing apparatus must also be traveled to in a defined manner by means of the placement region for the total product. The invention thus goes far beyond a mere multiplication of the principle known from EP 1 762 346 A1.

The invention is furthermore not restricted to the generation of total portions which only comprise a plurality of individual portions of one or more cut-off product slices, i.e. the total portions do not only have to comprise cut-off product slices. In other words, the total portion to be formed can also comprise such products which are not cut-off product slices or portions of such slices. Such products will also be called side products in the following. These side products can be foods such as grated cheese or also spices which are e.g. packaged in bags which can be placed on the placement area by means suitable transport technology, metering technology or handling and/or robot technology. Other possible side products are e.g. pasty substances such as mustard, ketchup, remoulade, sauces or marinades which can be added to the product slices or to the individual portions formed by the product sliced—e.g. again packaged portionwise—and can thus likewise form a component of a total portion in the sense of the invention. The side products can in principle also be added in a loose or open manner in that they are e.g. filled into corresponding recesses of a product placement area by means of a suitable dispensing or metering technology or are added directly to one or more of the individual portions comprising slices.

When a “total portion” is spoken of in the following, this is therefore also to be understood in the following as a total product called a “total article” which can comprise one or more side products in addition to the respective individual portions comprising one or more product slices, with it, however, not being compulsory that a total portion comprises such a side product.

Consequently, the machine assembly in accordance with the invention can also comprise such machine units which are not one of the slicing apparatus or the placement device. In accordance with a possible embodiment of the apparatus, provision can accordingly be made that the machine assembly additionally comprises at least one output device which can likewise be controlled by the system control on the basis of the predefined machine data set and with which at least one side product can be added to the placement region.

In this case, the user can then create the total portion by means of the display device not only from the individual portions, but also from one or more side products, wherein the evaluation device also predefines a configuration data set taking account of these side products and the system control predefines a machine data set from this configuration data set which also controls the output devices such that the total portion also comprising the side products is produced by placing the side products in addition to the individual portions in accordance with the previously created total portion.

In accordance with an embodiment of the invention, the machine data set for the machine units comprises respective configuration data dependent on the created total portion, setting data and/or operating data which predefine a configuration, setting or operating mode of the respective machine unit required for the formation of the total portion. The machine data set therefore ensures that the machine units required for a respective total portion are configured, set and/or operated, in particular automatically, such that the machine assembly produces the respective desired total article.

Provision is made in a possible embodiment that product slices, individual portions and a total portion can be represented realistically or symbolically on the display device and the display device has a configuring function b means of which a user can graphically create the total portion on the display device from a plurality of product slides, in particular by creating the individual portions from the product slices and by creating the total portion from the individual portions.

In this respect, the display device or the configuring function can provide the user with a design latitude which can generally be predefined as desired. A specific number of individual portions respectively comprising one or more slices can, for example, be predefined so that the user only has the possibility of forming a total portion with these predefined individual portions. Alternatively, the user can also be given the possibility of creating self-determined or any desired individual portions and of using them to create generally any desired total portions on the basis of which the control of the machine assembly then takes place. Alternatively or additionally, a design latitude granted to the user can be restricted by the respective present machine assembly and/or by an instantaneous configuration and/or setting of the machine assembly. Expressed in simplified terms, the invention makes it possible that from the start the machine assembly only offers the user what is possible for it with the machine assembly. This offer can thus include the output of instructions or recommendations directed to the user on how the machine devide is to be changed by specific conversion and/or setting measures to be able to produce specific desired total portions. The corresponding information can in particular be automatically generated and can be represented by means of the display device. An operator can thereby directly view the change effort or the effort required for the conversion and/or creation and can either release it or the operator can select or create a different total portion and can then request a new representation or output for this new composition.

The creation of individual portions from one or more product slices and the composition of total portions from one or more individual portions and optionally from one or more side products can in principle take place as is explained in EP 1 762 346 A1 in connection with the formation of portions from a plurality of product slices. The display device can in particular comprise a touchscreen for this purpose on which the user can move slices or individual portions represented realistically or symbolically using a finger or an input device. Reference is herewith explicitly made to the content of EP 1 762 346 A1 with respect to this possible functionality of the apparatus in accordance with the invention.

Provision can furthermore be made in accordance with the invention that the evaluation device is configured to predefine, in particular to calculate, the configuration data set from the positions of the product slices and/or individual portions forming the created total portion on the display device. It is hereby ultimately achieved that the evaluation device, the system control and the individual machine units of the machine assembly together implement what the user sees on the display device.

Provision can be made in accordance with the invention that a configuration region for the total portion can be represented on the display device, in particular in the form of a placement surface associated with the total portion to be formed, preferably a product placement area which is e.g. formed as a shell, a tablet or a so-called tray.

The placement area on which the total portion is formed by means of the machine units can in particular be separate carriers or receivers in which the total portions respectively remain and which only have to be closed or packaged respectively. If placement does not take place directly into a product placement area, the configuration region in particular corresponds to a reserved placement surface on a conveying device, e.g. on a conveying belt, from which the total portion is e.g. handed over to a packaging machine at the end of the placement procedure. The placement area can thus only be a defined section on a conveying device of the placement device, for example a section on a continuous conveyor belt or on a movable carrier from which the total portion still has to be removed.

So that the user can coordinate the total portion to be formed with respect to shape and size with the respective desired or available placement region, for example on a product shell predefined by the customer, it is possible in accordance with an embodiment of the invention to represent at least the outlines of such a product shell relevant to the total portion on the display device. Within these limits, the user can arrange the individual portions and optionally the added products with reference to predefined criteria or individually in the sense of an appealing product presentation.

Provision can furthermore be made in accordance with the invention that a configuration region, in particular respectively in the form of a placement surface associated with the individual portion to be formed, can additionally be represented on the display device.

Accordingly, in accordance with the invention, a respective configuration region can also be represented on the display device for optionally provided added products.

The formatting regions for individual portions and added products can overlap and/or partly mesh with one another. The placement order or the overlap can thus also be determined in the sense of an arrangement by “foreground” and “background”.

The representation of one or more configuration regions for the total portion or for the individual portions and/or added products not only allows the user to adapt the creation of the total portion to the shape and size of the available placement region. Provision can furthermore be made that the evaluation device is configured to take account of the position of the created total portion relative to the configuration region in the predefining of the configuration data set. Since the machine units are controlled on the basis of the machine data set and since the machine data set is predefined by the configuration data set, it can also be ensured by the representation of one or more configuration regions in the creation of the total portion that the individual portions and optionally the side products are not only positioned correctly relative to one another, but are also respectively placed at the correct position on the placement surface. In other words, the configuration regions not only assist the user in the design of the total portion, but the configuration regions also ensure a placement of the total portion in an exact position, for example, on product shells traveling successively to the individual slicing apparatus and optionally to one or more output devices.

Provision can in particular be made that the configuration regions define those limits within which the respective machine units are technically able to position the respective individual portions or added products on the placement area. In other words, a configuration region can e.g. represent the range and/or the operative region of a feeder or of a robot such as is present at the respective machine unit with a placement region positioned in accordance with its purpose relative to this machine unit.

A particular advantage of the invention generally comprises the “machine side”, on the one hand, and the “design side”, on the other hand, being put into relation with one another such that a reliable, efficient and safe operation of the machine assembly is ensured and the time effort, the proneness to error in the portion design and the machine assembly effort for implementing the design are minimized.

In this respect, in accordance with the invention, the system control can be configured to provide a state data set representing the respective machine state. The configuration device or the system control can be configured to set the total portions which can be created by means of the display device and the total portions which can be formed by means of the machine assembly in relation to one another on the basis of this state data set.

A possible application, for example, comprises allowing the user to create only such total portions for which the machine assembly is actually designed. In a possible variant, this means the provision of a variation range only on the basis of automatically possible adjustments or settings without manual interventions by a user in the sense of mechanical conversion work. In another variant e.g. in the sense of a next stage, a variation range can be made possible on the basis of the normal machine utilization. This can, for example, include a change from a single-track slicing to a multi-track slicing at one or more slicers.

Another application, for example, comprises admittedly allowing the user the creation of any desired total portions, but giving him suitable instructions or recommendations for converting or changing the settings of the machine assembly when the instantaneous state of the machine assembly does not allow the production of a specific total portion just created by the user at the display device, at least not without further measures.

Provision can furthermore be made in accordance with the invention that the configuration device is configured to adapt the total portions and/or individual portions which can be created by means of the display device to the machine state by means of the state data set, in particular to the respective configuration and/or settings of the machine units.

Provision can alternatively or additionally be made that the configuration device is configured to represent the individual portions and/or total portions possible on the basis of the respective machine state on the display device by means of the state data set. It is also possible that suitable present configurations from a memory are presented as a selection which can be processed and stored faster.

It is furthermore possible in accordance with the invention that the display device is used to communicate information on the machine assembly to the user, e.g. in the form of current data, potentially possible data or configuration data and/or setting data required for one or more specific total portions.

It is possible in this connection that the configuration device is configured to represent information on the display device by means of the state data set which relates to the respective machine state, in particular to the respective configurations and/or settings of the machine units. This can in particular take place broken down by the individual machine units. The information can hereby in particular be accessed in structured form.

The possibility provided in accordance with the invention of communication between the machine side, on the one hand, and the portion design side, on the other hand, also allows the user to be informed how the machine assembly optionally has to be changed to produce one or more—explicitly or potentially desired—overall portions. This is particularly advantageous if, in accordance with an embodiment of the invention, this information also covers the current operating and assembly state of the machine side.

Provision can furthermore be made in accordance with the invention that the configuration device or the system control is configured to determine a desired state data set from a configuration data set, to compare the desired state date with the state data set and to determine changes of the machine state which are required to be able to form a total portion corresponding to the configuration data set.

For this purpose, the configuration device can be configured to present and/or output the required changes on the display device. This can in turn take place broken down by the individual machine units.

A particularly comfortable embodiment can comprise, in accordance with the invention, the configuration device being configured to represent and/or to output the required changes on the display device in the form of conversion instructions and/or setting instructions to carry out configuration changes and/or setting changes at the individual machine units. In this respect, the user therefore does not obtain any error message or does not only obtain an error message if a total portion which can instantaneously be produced is desired or created, but the user rather receives specific information on how the current machine assembly has to be converted or set so that the desired total portion can be produced.

In accordance with an advantageous further development, a distinction is made in the representation and/or output between settings taking place automatically, on the one hand, and settings or conversions to be actuated manually, on the other hand.

If one or more machine units are able to do this, provision can be made in a further embodiment that the system control is configured to control the individual controls of the machine units such that at least one of the required changes is automatically carried out at at least one of the machine units.

An association and/or marking of the measures to be taken and of corresponding representations and/or outputs with respect to the individual machine units can in particular take place with respect to required changes. For this purpose, reports can e.g. be represented or output in groups or as lists or can be provided with codes.

Provision can be made in the method in accordance with the invention that the machine assembly additionally comprises at least one output device which is likewise controlled by the system control on the basis of the predefined machine data set to add at least one side product to the placement region.

The display device can have a configuration function by means of which a user can graphically create the total portion from a plurality of product slices on the display device, in particular by creating the individual portions from the product slices and the total portion from the individual portions, with product slices, individual portions and a total portion being represented realistically or symbolically on the display device.

The configuration data set is preferably predefined, in particular calculated, from the positions of the product slices and/or individual portions forming the created total portion on the display device.

Provision is furthermore in particular made that a configuration region for the total portion and/or for each individual portion is moreover represented on the display device, in particular in the form of a total portion to be formed or of the placement surface associated with the individual portion to be formed.

As already mentioned at another point, the formatting regions which are provided for individual portions, and optionally for additional products, can at least partly overlap and/or at least partly mesh with one another. It can thus be fixed in principle by the user for every part of the total portion whether this part is disposed more in the foreground or in the background or forms the foreground or the background of the total portion so that the placement order is determined.

Provision can be made that the position of the created total portion relative to the configuration region is taken into account when predefining the configuration data set.

In accordance with an embodiment of the invention, a state data set representing the respective machine state can be provided, with the total portions which can be created by means of the display device and the total portions which can be formed by the means of the machine assembly in particular being set into relation with one another on the basis of the state data set.

Provision is preferably made that the total portions and/or individual portions which can be created by means of the display device are adapted by means of the state data set to the machine state, in particular to the respective configurations and/or settings of the machine units.

Provision can be made that the individual portions and/or total portions possible on the basis of the respective machine state are represented on the display device by means of the state data set.

Provision can furthermore be made in accordance with the invention that information which relates to the respective machine state, in particular to the respective configurations and/or settings of the machine units, is represented on the display device, in particular broken down by the individual machine units, by means of the state data set.

Provision is furthermore made in accordance with an embodiment of the invention that a desired state data set is determined from a configuration data set, the desired state data set is compared with the state data set and changes of the machine state are determined which are required to be able to form a total portion corresponding to the configuration data set.

The required changes are preferably displayed and/or output on the display device, in particular broken down by the individual machine units.

The required changes can be represented on the display device in the form of conversion instructions and/or setting instructions for carrying out configuration changes and/or setting changes at the individual machine units. Provision can be made in this connection that it is made possible for the user to release the changes, in particular at the display device, with the respective setting automatically only taking place subsequent to such a release.

Provision can furthermore be made in accordance with the invention that the individual controls of the machine units are controlled such that at least one of the required changes is automatically carried out at at least one of the machine units.

Reference is also made to the above statements on the apparatus in accordance with the invention and on its possible embodiments with respect to further possible embodiments and advantages of the method in accordance with the invention and its above-mentioned further developments.

Further developments of the apparatus in accordance with the invention and of the method in accordance with the invention also result from the following statements, from the dependent claims and from the drawing.

The manner of the setting up of the machine units, in particular of the slicing apparatus and optionally of the output devices for side products, is generally arbitrary. The slicing apparatus can, for example, stand next to one another or behind one another or can be arranged along a closed or open line, for example on a part circle, in L shape or in T shape. A single central system control is in particular provided for all machine units.

A special feature of the invention comprises not only individual portions being able to be created in advance by means of the display device, i.e. not only working in a single plane with the display device. The invention rather so-to-say makes possible a three-dimensional product design since it can be predefined for each individual portion whether it is to lie above or below one or more other individual portions or between two other individual portions if—as is in particular frequently desired in practice with multi-type packaging for reasons of an appealing product presentation—the individual portions forming the total portion are to overlap one another.

Since a plurality of slicing apparatus are used in accordance with the invention, the placement shapes of the individual portions can be different. For instance, a slicing apparatus can be provided with a turntable, for example, on which a circular placement shape can e.g. be realized. Different placement types such as overlapping, stacking or shaved meat can furthermore in this manner be individually associated with the individual portions.

A particularly preferred, albeit also not compulsory, embodiment of the invention comprises, as already mentioned, working with food products of different types. For instance, each slicing apparatus can be operated with a single track, for example, in which a specific product is sliced, with the products of the individual slicing apparatus being different. It is alternatively possible to provide at least one multi-track slicing apparatus and to slice products of different types in its tracks.

The invention is, however, also particularly advantageous if only products of the same type are sliced. Each slicing apparatus can then provide a specific placement design of the respective individual portion so that a total portion results overall such as is not possible with a single slicing apparatus despite using only one single product type.

Provision can furthermore be made in accordance with the invention that the total portion comprises a single product type. The formation of such total portions can take place in an efficient manner by a multi-track slicing by means of only one single slicing apparatus.

A further advantage of the invention thus comprises individual components of the machine assembly being able to be passive depending on the requirements. If a specific product type or placement shape, for which a specific slicing apparatus is provided, is not required in a respective desire total portion, this can, for example, be recognized by the evaluation device and can be taken into account in the provision of the configuration data set so that the system control leaves the respective machine unit out of consideration in the production of the total portion.

A further advantage of the invention comprises a particularly fast production of total portions being possible if, for example, all the slicing apparatus are equipped with the same product type and if comparatively simple placement shapes are desired which can be realized when the slicing apparatus are arranged in parallel with one another or in series after one another and all the individual portions generated by the slicing apparatus have the same placement shape. This can, for example, be the case when a total portion is desired whose individual portions have the same appearance and in which only the relative arrangement of the individual portions among one another is important.

A special feature of the invention comprises the fact that, after the end of a portion design carried out at the display device on the basis of information on the machine assembly, a recommendation or an instruction can be given for its setting up on the basis of which the user can take corresponding conversion measures and/or setting measures or can trigger measures which can be carried out automatically. It is in particular possible that only those possible total portions or variants of the created total portion are displayed to the user during the product design or subsequent thereto for a further processing or for a further selection which are sensible or which can be carried out at all with respect to the respective product or products, with respect to the product placement areas to be filled in each case, in particular trays, with respect to the technical possibilities of the individual machine units and/or with respect to the possibilities for the control of the machine assembly.

Such a guidance or instruction of the user can be configured dynamically or adaptively to the extent that the further possibilities are adapted in accordance with the respective circumstances, in particular of the machine assembly, or are reduced to sensible possibilities after each selection made by the user. Provision can furthermore be made that preceding, stored settings are imported, in particular automatically, which can either be used directly without a change or which can be changed by the user.

Recommendations or instructions to the user which are in particular presented on the display device can include the association and/or the manner of the loading of the slicing apparatus with one or more products to be sliced. In other words, the configuration device or the system control can e.g. inform the user of which slicing apparatus can be loaded in which manner with which product so that the machine assembly is able as a whole to generate the respective desired total portion in an ideal manner.

An automatic association of placement regions of the placement device, in particular an automatic tray association, is furthermore also possible in accordance with the invention. The user can thus be informed by means of the display device as to which trays are located in which tray store or with which type of tray one or more tray stores are to be loaded to be able to produce a respective desired total portion.

It is also possible in accordance with the invention to allow information to enter into the system control and/or into the product design which originates from sensors installed in the region of the machine assembly such as a device, in particular an optical device, for detecting trays or other product placement areas. Such a sensor system can influence conversion recommendations and/or setting recommendations to the user via the system control or the configuration device or can display the existing conversion possibilities and/or setting possibilities to the user.

In accordance with the invention, the machine assembly can generally comprise any desired transport and conveying technology for products, individual portions and further objects such as in particular product placement areas, e.g. trays, for the total portions, with these technical devices also being able to be controlled on the basis of the respective portion created by the user at the display device. These technical devices can be connected both upstream and downstream of the individual stations, in particular of the slicing apparatus. In this respect, they can, for example, be devices for rotating individual portions or total portions or product carriers or product placement areas. The technical devices can furthermore comprise switches with which specific stations, in particular slicing apparatus, can be bypassed or the placement regions and/or individual portions can be associated with the individual stations or slicing apparatus.

In general terms, the invention thus allows an intelligent, application-related and potentially dynamic or adaptive interaction between complex “hardware” which is generally arbitrary, on the one hand, with which a variety of total portions can be produced and a portion designer, on the other hand, which is comfortable since it is configured for visual and intuitive use and at which a user only has to create the desired final result—namely a desired total portion. The system control thereupon sets the individual machine units in an ideally mutually coordinated manner such that the desired total portions are produced with a high throughput. In other words, the user is saved the time-consuming and arduous work by the invention of programming or setting the total networked machine system in all details such that the respective desired total portion is also actually produced. The portion design itself can also be made easier for the user in that information on the total machine system is used intelligently such as had already been explained above in general and with reference to specific examples.

In accordance with a further embodiment of the invention, a total weight for the total portion can be predefined as a target weight which is taken into account in the control of the machine assembly by the control so that the machine assembly observes the target value as exactly as possible in the formation of the total portion. It is also possible to predefine a single portion weight as the target weight for at least one or for each individual portion. Alternatively or additionally, the number of slices for at least one or for each individual portion can be predefined.

The placement device can serve for the transport of the total portion formed piece by piece from station to station, i.e. from machine unit to machine unit, with it also being possible to use the placement device for the transport from a machine unit onto a different transport device, e.g. in the form of a collective belt. In this respect, the components such as a portioning belt, a control belt, scales and/or a buffer belt, which are required for the provision of an individual portion or of a side product can be provided for each machine unit, in particular for each slicing apparatus.

Alternatively or additionally, the placement device can serve for the design of the total portion or of individual portions in that e.g. a specific placement shape of the portion is realized by a corresponding control of the placement device.

The placement can furthermore comprise a rotating and/or turning of individual product slices and/or of whole individual portions.

The individual slicing apparatus are preferably each specialized in the slicing of only one single product type or of a small number of different product types, in particular for reasons of cutting quality and of hygiene.

The slicing apparatus can each be configured and/or operated as single-track or as multi-track.

It is generally not compulsory either in the apparatus in accordance with the invention or in the method in accordance with the invention that the configuration data set provided by the evaluation device is determined by a total portion created at the display apparatus. The configuration data set can also be predefined in a different manner in that e.g. the user enters a code which represents an already completely designed total portion.

The invention will be described in the following by way of example with reference to the drawing. There are shown:

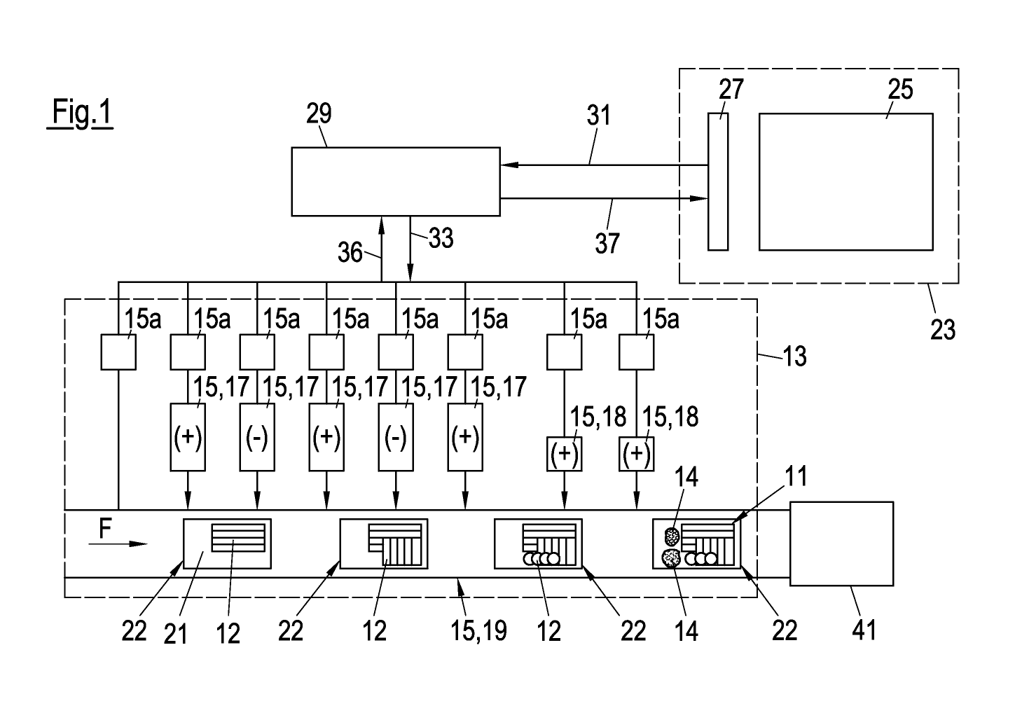

FIG. 1 schematically, an example for an apparatus in accordance with the invention for forming total portions with which a method in accordance with the invention for forming total portions can be carried out; and

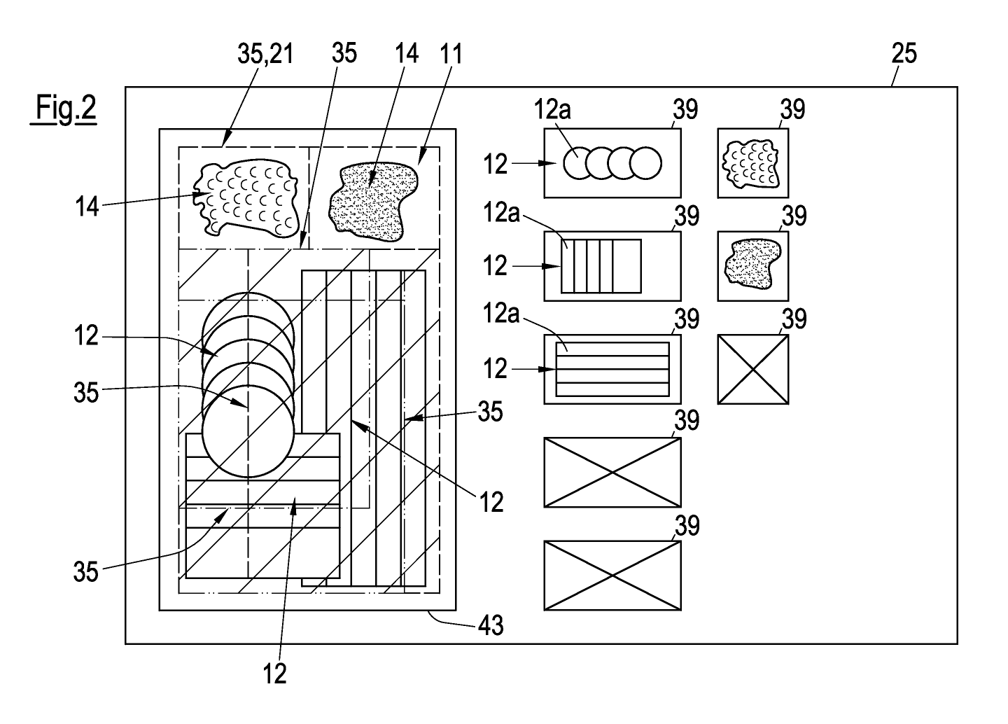

FIG. 2 schematically, a possibility for a representation such as possible in accordance with the invention on a display device in accordance with the invention.

In accordance with FIG. 1, an apparatus in accordance with the invention with which total portions 11 (cf. also FIG. 2) can be formed comprises a machine assembly 13 having a plurality of machine units 15. The apparatus furthermore comprises a configuration device 23 as well as a central system control 29 which inter alia communicates with an evaluation device 27 of the configuration device 23 and with individual controls 15a which are associated with the machine units 15.

In the embodiment shown, the machine assembly 13 comprises five slicing apparatus 17 in the form of high-performance slicers, two output devices 18 and a placement device 19 in the form of a conveying path which is configured, for example, as a continuous conveyor belt or as a transport device for product placement areas 22, e.g. in the form of so-called trays, each having a placement region 21. Those machine units 15 are provided with a “(+)” which are active in an exemplary application for the production of a total article 11. Machine units 15 provided with a “(−)”—here two of the slicing apparatus 17—are passive, since they are not required for this application.

Within an application, a machine unit 15 can e.g. change its state multiple times between “active” and “passive” in order, for example, to be equipped with a new product. The work of the passive machine unit 15 can then be taken over by another machine unit 15.

The slicing apparatus 17 are generally known slicers which each have a product feed with which food products to be sliced can be fed on one track or on multiple tracks to a cutting plane in which a cutting blade, for example a circular blade or a scythe-like blade, moves in a rotating and/or revolving manner.

Each slicer can produce individual portions 12 which each comprise one or more product slices 12a (in the example shown—cf. also FIG. 2—salami, ham and bacon).

To form the individual portions 12, each slicer comprises a portioning unit which is not shown and which is configured in accordance with a respective desired placement shape. The individual portions 12 move from the portioning device via conveying devices, not shown, to the placement device 19. The delivery of the individual portions 12 on the product placement areas 22 can take place in generally any desired manner. Devices for delivering or handing over portions comprising product slices 12a or a plurality of slices 12 are generally known. Robots can be used, for example. Alternatively or additionally, generally known feed technology can be used. It is generally also possible that the slicers 17 are arranged with respect to the placement device 19 such that the cut-off product slices 12a fall directly onto the respective product placement area 22.

The slicers 17 arranged next to one another here along the placement device 19 or their delivery or handover points are traveled to one after the other by the individual product placement areas 22. In this respect, the product placement areas 22 can either only be traveled in a direction F or—depending on the application—can also be moved in the opposite direction to travel through the slicers 19 or their placement or handover points in a respective predefined order.

In this manner, a total portion 11 from a plurality of individual portions 12, which are produced and provided by one of the slicers 17 respectively, can be formed by the machine assembly 13 on each product placement area 22.

In addition to the individual portions 12 comprising a respective plurality of cut-off product slices 12a, the total portion 11 can comprise one or more side products 14 (cf. also FIG. 2) which are likewise placed on the product placement area 22 or are applied to the product placement area 22. The output devices 18 are provided for this purpose. As already mentioned in the introductory part, the side products 14 can be foods packed in bags such as grated cheese or spice and pasty products such as mustard, ketchup or remoulade. It is, however, also possible to add non-food products such as packaged wet tissues for cleaning the hands, cutlery, toothpicks or utensils of any kind which are to be added, for example, as part of marketing campaigns.

The individual portions 12 and the optionally provided side products 14 overall form a total product or total article present on the product placement area 22 which will also simply be called a total portion 11 in the following.

In the embodiment shown, a packaging machine 41 in which the product placement areas 22 are closed or are provided with an outer packaging adjoins the placement device 19. Such a packaging machine 41 can form a component of the machine assembly 13, with this not being compulsory, however.

The display device 25 and its significance for the above-explained machine assembly 13 and for the user will be looked at in more detail in conjunction with FIG. 2.

The evaluation device 27 with which the central system control 29 communicates is connected to the display device 25. The evaluation device 27 is inter alia able to evaluate a total portion 11 created by the user by means of the display device 25 such that a configuration data set 31 is provided for the system control 29. The system control 29 is in turn able to determine a machine data set 33 on the basis of the configuration data set 31 with which machine data set it is possible to control the individual controls 15a of the machine units 15 such that the machine assembly 13 produces a total portion 11 such as was previously designed by the user by means of the display device 25.

The evaluation device 27 can be integrated in the system control 29 or vice versa. It is generally also possible to integrate the individual controls 15a of the machine units 15 into the system control 29 or vice versa.

The apparatus in accordance with the invention is consequently capable of an information processing in which what the user designs in a manner particularly comfortable for him is translated into a “machine language” with parameters in the background to cause the machine units 15 to produce what was created on the display device 25, namely a respective desired total portion 11 of a plurality of individual portions 12 and optionally of one or more side products 14.

As already mentioned in the introductory part, a diverse interplay of generally any kind can take place between the display device 25, on the one hand, and the machine assembly 13, on the other hand, also while including a flow of information taking place in the other direction. In this respect, machine information 36 originating from the individual machine units 15 in the form of state data sets 37 can be handed over by means of the system control 29 to the evaluation device 27 which provides that the machine information 36 or information, recommendations and/or instructions for the user derived therefrom is/are presented on the display device 25.

Expressed in figurative terms, the user can say by means of the display device 25 of the machine assembly 13 (cf. FIG. 1) shown in FIG. 2 where and in which orientation and in which order different individual portions 12 and optionally provided side products 14 have to be positioned on the respective product placement area 22 so that a respective desired total portion or a respective desired total article 11 results.

The display device 25 can be configured as a touchscreen to allow a simple operation by a finger. A conventional screen can, however, also be used in conjunction with other input devices.

In the embodiment shown, the display on the touchscreen comprises a plurality of selection regions 39 as well as a design region 43. Different individual portions 12 can be selected at the selection regions 39 and can in particular be dragged onto the design region 43 using a so-called drag & drop function and can be dropped at a respective desired position there. It is e.g. also possible that first the individual portions 12 each having one product type are designed and/or compiled in the selection regions 39, whereupon the selection and the design of the total portion 11 takes place.

The individual portions 12 can partly overlap in the total portions 11 which arise. The plane in which an individual portion 12 lies with respect to the other individual portions 12 in the total portion 11 results from the order of the placement of the individual portions 12 in the design region 43. In the same manner, the side products 14 can be dragged to the design region 43 and can be dropped at a respective desired position there.

Depending on the respective application, a plurality of side products 14 can overlap one another and/or can be arranged overlapping with one or more individual portions 12.

Selection regions 39 not available for a respective application can be not visible at all or can admittedly be visible, but deactivated, as is indicated in FIG. 2 by the selection regions 39 provided with a cross.

The individual portions 12 which can be selected can be fixedly predefined. Alternatively, it can be made possible for the user to vary the individual portions 12, for example, with respect to the number of the product slices 12a, with respect to the degree of overlap of the individual product slices 12a and/or with respect to the relative arrangement of the products slices 12a among one another. This can be made possible for the user, for example, in a relatively restricted framework. Alternatively, the user can be put into a position to design any desired individual portions 12. Provision is in particular made for this purpose that one or more further screens are provided within the total application which includes the screen shown schematically in FIG. 2, said further screen(s) allowing the user to create individual portions 12. The designing of individual portions 12 can take place, for example, in that manner which is described in EP 1 762 346 A1 already mentioned in the introductory part in connection with the configuration device explained there. Reference is herewith explicitly made to this known portion design.

The design region 43 of the display device 25 is provided with a plurality of configuration regions 35 which facilitate the portion design for the user and which ensure that only such total portions 11 can be created which satisfy specific conditions. These conditions can be of a variety of types. It can thus be predefined on the basis of machine information 36 (cf. FIG. 1), for example, that not the total placement region 21 is respectively provided for the individual portions 12 and the side products 14, but rather only a part thereof. These part regions can overlap at least partly.

The machine information 36 can include a piece of information on the shape and size of the product placement areas 22 respectively present or to be used. A configuration region 35 in the design region 43 of the display device 25 can consequently correspond to the placement region 21 of this product placement area 22.

The positions and orientations of the individual portions 12 and of the side products 14 relative to the configuration region 35 corresponding to the placement region 21 in the design region 43 then correspond to the manner how the slicers 17 and the output devices 18 can place the real individual portions 12 and side products 14 on the placement regions 21 of the real product placement areas 22. In other words, it is ensured by the configuration regions 35 that the individual components of the total article 11 relative to one another and the total article 11 relative to the product placement area 22 are positioned and orientated correctly.

Some examples occurring in practice for a conversion of a machine assembly conceived as a multi-type plant will be named in the following:

With a slicer only slicing cheese, the type of cheese and/or the format of the cheese bar changes so that cutting parameters and abutments have to be set and optionally product grippers have to be adjusted.

With a slicer only slicing boiled sausage, the type of sausage and/or the format of the sausage strings changes so that cutting parameters and abutments have to be set and optionally product grippers have to be adjusted.

With a slicer only slicing black pudding or salami, the type of sausage and/or the format of the sausage strings changes so that cutting parameters and abutments have to be set and optionally product grippers have to be adjusted.

If only packages having a single product type are to be produced in a so-called mono-type operation, only a single slicer can then be in operation in the total plant which simultaneously slices products in a plurality of tracks, with mostly at least approximately the same throughput of portions or packages being achieved as in a multi-type operation. The producers using the invention are consequently very flexible and are thus able also to produce small lots each having different packaging inexpensively and fast so that a temporary standstill of parts of the total plant is accepted.

With regard to changes of the packaging for the total portion, the so-called lower shell of the packaging e.g. frequently remains unchanged, with the so-called upper film, however, having to be changed since e.g. the size and/or the position of a print to be applied to the upper film changes, which can require a different arrangement of the individual components of the total portion in the lower shell.

### REFERENCE NUMERAL LIST

11 total portion, total article
12 individual portion
12a product slice
13 machine assembly
14 side product
15 machine unit
15a individual control
17 slicing apparatus, slicer
18 output device
19 placement device
21 placement region
22 product placement area, tray
23 configuration device
25 display device
27 evaluation device
29 system control
31 configuration data set
33 machine data set
35 configuration region
36 machine information
37 state data set
39 selection region
41 packaging machine
43 design region
F conveying direction

1. An apparatus for forming total portions which at least comprise product slices which are cut-off from a plurality of food products, wherein the total portions each comprise a plurality of individual portions which are each formed from at least one product slice, having
a machine assembly having a plurality of machine units, comprising
a plurality of slicing apparatus which each have at least one product feed with which at least one product to be sliced is fed to a cutting plane in which at least one cutting blade moves; and
a placement device which comprises at least one placement region which can be traveled between the slicing apparatus and on which a total portion is formed from product slices cut off by means of the slicing apparatus;
a configuration device having
a display device; and
an evaluation device communicating with the display device; and
a system control which communicates with individual controls associated with the machine units and with the configuration device,
wherein a respective total portion can be created from a plurality of different individual portions by means of the display device;
wherein the evaluation device is configured to provide a configuration data set determined by a predefined total portion; and
wherein the system control is configured to predefine a machine data set from a provided configuration data set and to control the machine assembly on the basis of the predefined machine data set such that total portions corresponding to the predefined total portion are formed,
in that individual portions formed successively by different slicing apparatus are placed on the placement region of the placement device.

2. The apparatus in accordance with claim 1,
in which the machine assembly further comprises at least one output device which can likewise be controlled by the system control on the basis of the predefined machine data set and with which at least one side product can be added to the placement region.

3. The apparatus in accordance with claim 1,
in which the machine data set for the machine units comprises configuration data, setting data and/or operating data which each depend on the created total portion and which predefine a configuration, setting or operating mode of the respective machine unit required for the formation of the total portion.

4. The apparatus in accordance with claim 1,
in which product slices, individual portions and a total portion can be represented realistically or symbolically on the display device and the display device has a configuration function by means of which a user can create the total portion graphically from a plurality of product slices on the display device.

5. The apparatus in accordance with claim 1,
in which the evaluation device is configured to predefine the configuration data set from the positions of the product slices and/or individual portions forming the created total portion on the display device.

6. The apparatus in accordance with claim 1,
in which a configuration region for the total portion can also be represented on the display device.

7. The apparatus in accordance with claim 1,
in which a configuration region can also be represented for each individual portion on the display device.

8. The apparatus in accordance with claim 6,
in which the evaluation device is configured to take account of the position of the created total portion relative to the configuration region when predefining the configuration data set.

9. The apparatus in accordance with claim 7,
in which the evaluation device is configured to take account of the position of the created total portion relative to the configuration region when predefining the configuration data set.

10. The apparatus in accordance with claim 1,
in which the system control is configured to provide a state data set representing the respective machine state.

11. The apparatus in accordance with claim 10, wherein the configuration device or the system control is configured to set the total portions which can be created by means of the display device and the total portions which can be formed by means of the machine assembly into relation with one another on the basis of the state data set.

12. The apparatus in accordance with claim 11,
in which the configuration device is configured to adapt the total portions and/or individual portions which can be created by means of the display device by means of the state data set to the machine state.

13. The apparatus in accordance with claim 10,
in which the configuration device is configured to represent the individual portions and/or total portions possible on the basis of the respective machine state on the display device by means of the state data set.

14. The apparatus in accordance with claim 10,
in which the configuration device is configured to represent information which relates to the respective machine state on the display device by means of the state data set.

15. The apparatus in accordance with claim 10,
in which the configuration device or the system control is configured to determine a desired state data set from a configuration data set, to compare the desired state data set with the state data set and to determine changes of the machine data set which are required to form a total portion corresponding to the configuration data set.

16. The apparatus in accordance with claim 15,
in which the configuration device is configured to represent and/or output the required changes on the display device.

17. The apparatus in accordance with claim 15,
in which the configuration device is configured to represent and/or output the required changes on the display apparatus in the form of conversion instructions and/or setting instructions for carrying out configuration changes and/or setting changes at the individual machine units.

18. The apparatus in accordance with claim 15,
in which the system control is configured to control the individual controls of the machine units such that at least one of the required changes is carried out automatically at at least one of the machine units.

19. A method for forming total portions which at least comprise product slices, wherein the product slices are cut off from a plurality of food products and wherein the total portions each comprise a plurality of individual portions which are each formed from at least one product slice, having
a machine assembly having a plurality of machine units, comprising
a plurality of slicing apparatus which each have at least one product feed with which at least one product to be sliced is fed to a cutting plane in which at least one cutting blade moves; and
a placement device which comprises at least one placement region which can be traveled between the slicing apparatus and on which a total portion is formed from product slices cut off by means of the slicing apparatus;
a configuration device having
a display device; and
an evaluation device communicating with the display device; and
a system control which communicates with individual controls associated with the machine units and with the configuration device,
wherein a respective total portion is created from a plurality of different individual portions by means of the display device;
wherein a configuration data set determined by a predefined total portion is provided by means of the evaluation device; and
wherein a machine data set is predefined by means of the system control from a provided configuration data set and the machine assembly is controlled on the basis of the predefined machine data set such that total portions corresponding to the predefined total portion are formed,
in that the placement region of the placement device is traveled between the slicing apparatus and individual portions formed on the placement region successively by different slicing apparatus are placed down.

20. The method in accordance with claim 19,
wherein the display device has a configuration function by means of which a user can create the total portion graphically on the display device from a plurality of product slices.

21. The method in accordance with claim 19,
wherein product slices, individual portions and a total portion are represented realistically or symbolically on the display device.
